(19) United States
(12) Patent Application Publication
(10) Pub. No.: US 2024/0191152 A1
(43) Pub. Date: Jun. 13, 2024

(54) SYSTEMS AND METHODS FOR PRODUCTION OF RENEWABLE HYDROGEN FOR WASTE COLLECTION AND WASTE MANAGEMENT CENTER VEHICLES

(71) Applicant: KORE INFRASTRUCTURE, LLC, El Segundo, CA (US)

(72) Inventors: Joseph E. Zuback, El Segundo, CA (US); Steven A. Wirtel, El Segundo, CA (US)

(21) Appl. No.: 18/286,385

(22) PCT Filed: Apr. 13, 2022
(86) PCT No.: PCT/US2022/024665

§ 371 Date: Oct. 11, 2023

Related U.S. Application Data
(60) Provisional application No. 63/174,083, filed on Apr. 13, 2021.

(51) Int. Cl. C10L 5/46; C04B 18/10; C09K 17/00; C10B 53/02; C10K 1/02; C10L 5/44; C10L 9/08

(52) U.S. Cl. CPC C10L 5/46; C04B 18/10; C09K 17/00; C10B 53/02; C10K 1/02; C10L 5/447; C10L 9/08; C10L 2290/02; C10L 2290/04; C10L 2290/06; C10L 2290/10

(57) ABSTRACT

Described are technologies including methods and systems that can be used to produce carbon-neutral and/or carbon-negative renewable gaseous fuel from various organic wastes. In some implementations, such renewable fuel can be used in vehicles that transport the wastes from the waste generators to centralized waste disposal locations and/or manage the wastes at the waste disposal locations.

### CROSS-REFERENCE TO RELATED APPLICATIONS

This application claims priority to U.S. Provisional Patent Application No. 63/174,083, “Systems and Methods for Production of Renewable Fuel for Steam Generation For Waste Collection and Waste Management Center Vehicles”, filed on Apr. 13, 2021, which is incorporated herein by reference in its entirety.

### BACKGROUND

Waste management includes strategies and technologies to dispose, reduce, reuse, and/or prevent waste. Common waste disposal methods include one or more of recycling, composting, incineration, landfills, bioremediation, waste to energy, and waste minimization. The handling and disposal of waste, for example, municipal waste, includes energy intensive processes, including, for example, the collection and transport of waste from homes to a municipal waste management facility using waste collection trucks, the handling or moving of waste at landfills, or the incineration of waste.

### SUMMARY

Disclosed in this specification (“herein”) are technologies including methods and systems that can be used to produce carbon-neutral and/or carbon-negative renewable gaseous fuels from various organic wastes. These renewable fuels can be used in vehicles that transport the wastes from the waste generators to centralized waste disposal locations and/or manage the wastes at the waste disposal locations. The technologies described in this specification can be used to reduce the carbon footprint of (organic) waste management processes, e.g., by extracting material (e.g., gas) from the waste that can be used as fuel for vehicles and/or other processes in waste management.

In one aspect, this specification describes a method for producing transportation fuel. The method includes heating, in a thermal conversion process, a solid feed material in the absence of oxygen to liberate gas and residual carbonaceous solid, the gas having a calorific value. The method includes utilizing a portion of the liberated gas to produce hydrogen for use as a transportation fuel. The method includes utilizing the remaining portion of the liberated gas to produce renewable heat and electricity to reduce the overall carbon intensity of the transportation fuel production process. The method includes capturing the residual carbonaceous solid as a waste product for landfill disposal or use as a fuel, soil amendment, concrete additive, or various carbon applications.

In one aspect, this specification describes a system for producing transportation fuel from carbonaceous waste for vehicles that transport the waste to and manage the wastes in landfills and other centralized waste management locations. The system includes a thermal conversion system configured to heat a solid waste feed material in the absence of oxygen to (a) liberate gas that comprises hydrogen and other constituents having a calorific value from the solid and (b) produce a residual carbonaceous solid. The system includes a preheating system that uses excess heat from the thermal conversion system configured to remove moisture, increase waste temperature, and/or reduce the heat required in the thermal conversion process. The system includes a gas cooling and/or cleaning system configured to treat liberated volatile gasses from the gas production unit to remove soot particles and/or gasses that condense into liquids at ambient temperatures to produce a biogas. The system includes a high-purity hydrogen production system configured to produce, from the biogas, a gas product containing greater than 99% hydrogen and a residual tail gas comprising removed non-hydrogen gasses in the biogas.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings (also “Figure” and “FIG.” herein), of which:

FIG. 1 is a flow diagram illustrating an example method for producing renewable fuel from organic waste for vehicles that collect and transport wastes to or manage the wastes in a landfill, material recycling facility, or other centralized waste management location; and

FIG. 2 is a flow diagram illustrating an example system for producing renewable fuel from organic waste for vehicles that collect and transport wastes to or manage the wastes in a landfill, material recycling facility, or other centralized waste management location.

### DETAILED DESCRIPTION

Renewable fuels have had periods of popularity and periods of disfavor, with their relevance often being tied to the global fossil fuel market. Renewables have generally been considered to have drawbacks including costs of production and overall heating capabilities that are typically lower than traditional hydrocarbons, such as natural gas, octane and other hydrocarbons. The costs and efficiencies of the renewable space have been under development for many years, in an effort to address these issues.

Described in this specification are technologies for of renewable fuel production. The technologies described in this specification can be used for the production of renewable fuel from wastes for vehicles that collect and transport wastes to or manage the wastes in a landfill, material recycling facility, or other centralized waste management locations.

Methane emissions resulting from the decomposition of organic waste in landfills are a significant source of greenhouse gas (GHG) emissions contributing to global climate change. 27 US states have regulations requiring diversion of organic wastes from landfills to beneficial use as a means to mitigate methane emissions. States like California, with the goal of achieving carbon neutrality by 2045, have been advised by Lawrence Livermore National Laboratory to consider carbon negative emissions pathways that physically remove CO₂ from the atmosphere by converting waste biomass to renewable fuels such as hydrogen fuels with sequestration of the carbon associated with the removed CO₂.

An example method to reduce the carbon footprint associated with waste collection and management vehicles is to replace at least in part diesel or gasoline fossil fuels used in these vehicles with renewable fuels, such as natural gas, landfill gas, or diesel produced from landfill gas. One potential drawback of this approach is that natural gas is also a fossil fuel, so the potential reduction in carbon footprint is only incremental. Another potential drawback is that the availability of landfill gas as a fuel may diminish over time as a result of organic waste diversion from landfills. Another potential drawback is that the carbon intensity of natural gas, landfill gas, or diesel produced from landfill gas may still be positive.

An example method to reduce the carbon footprint associated with waste collection, delivery and management vehicles is to replace internal combustion engines with electric motors, with power supplied via batteries or hydrogen-fueled fuel cells. One potential drawback is the cost associated with replacement of existing engines with electric motors or existing vehicles with new vehicles. Another potential drawback is that the carbon intensity of conventional means of producing electricity or hydrogen from fossil fuels is positive. Another potential drawback is the limited availability of renewable hydrogen with low or negative carbon intensity for fueling various vehicles required for collection, transportation and waste management that require hydrogen fuel.

The technologies including systems and methods described in this specification can improve the process for the production of carbon negative renewable gaseous fuel from various organic wastes to address these and other current potential drawbacks, e.g., by providing a process that generates renewable fuel that can be used in vehicles.

The technologies described in this specification include a method and system for producing renewable fuels for vehicles that collect and transport wastes to or manage the wastes in a landfill, material recycling facility, or other centralized waste management location.

The methods and systems described in this specification produce a renewable gaseous fuel and solid residual from various carbonaceous wastes. The gaseous fuel can be used to produce gases, e.g., hydrogen or methane, for use in vehicles. In some implementations, gaseous fuel can be used to produce gases, e.g., hydrogen or methane, for vehicles used to transport or manage the waste, e.g., the gaseous fuels can be produces on site at a waste management facility. In some implementations, gaseous fuel can be used to produce gases, e.g., hydrogen or methane and to produce heat and/or electricity, for example, for use within the process in order to reduce the demand for process energy from external fuel sources, e.g., fossil fuel. During the process described in this specification, a solid residual material is produced. The solid residual is comprised primarily of elemental carbon. Disposal methods, such as landfills, land application, and addition of the carbon to concrete can be used as means to permanently prevent carbon removed originally from the atmosphere via plant photosynthesis to return to the atmosphere. This process is called carbon sequestration. The technologies can be used to avoid introduction of carbon from fossil fuels from entering the atmosphere by replacement of fossil fuels, such as coal, with the solid residual.

The technologies described in this specification can utilize a wide variety of biogenic carbonaceous feedstocks generally considered organic wastes such as agricultural wastes, landscaping and other green wastes, animal manure, high hazard forestry waste, municipal wastewater treatment plant biosolids, food wastes, demolition wood, etc. that are typically sent to a landfill or other centralized waste management facility for disposal.

Methods previously known for replacing fossil fuels used in vehicles that transport or manage wastes have used renewable natural gas produced from anerobic decomposition of organic wastes within landfills or anaerobic digesters. Such methods rely upon sustained burial of organic wastes in landfills, which has been disallowed by recent regulations, or above-ground anaerobic digestion processes that generate a solid residual waste that can biodegrade to produce greenhouse gases.

The technologies including the method and systems described in this specification produce an alternative renewable gaseous fuel and carbonaceous solid. The technologies include a thermal conversion process that can be part of a waste-to-hydrogen conversion process. In a thermal conversion process, solid feed material is heated in the absence of oxygen at temperatures necessary to liberate combustible gasses that are a mixture of hydrogen, methane, carbon monoxide, carbon dioxide, and C2-C3 hydrocarbons. The solid material can be heated using an external combustion process (burner) without combustion of the feed material. In some implementations, the solid feed material is preheated. The material can be preheated using waste heat from the thermal process described herein, e.g., waste heat from the burner. The gases liberated from the solid feed material can be processed to produce (1) high-purity hydrogen, (2) a separate combustible gas following hydrogen separation called tail gas that can be used as a renewable energy source for the thermal conversion process, and (3) a residual carbonaceous solid. In some implementations, the hydrogen can be used as a renewable transportation fuel in vehicles used to transport or manage the organic wastes. In some implementations, the tail gas can be used as an onsite energy source to produce heat and/or electricity required by the process operations utilized in the systems and methods described in this specification. The residual carbonaceous solid can be disposed of via various methods, e.g., using methods that are recognized as carbon sequestration by regulators that determine the carbon intensity of fuel products. In some implementations, the residual carbonaceous solid can be sold as a solid renewable fuel, a soil amendment, concrete additive, or carbonaceous raw material.

The technologies described in this specification have many ecological and economical advantages over the use of fossil fuels or landfill gas as a vehicle fuel, e.g., in vehicles for waste transportation and disposal or management at a centralized facility. Because thermal conversion of organic waste to fuel reduces the demand for landfill waste disposal capacity, the renewable gasses that are produced can be used beneficially to produce a renewable hydrogen substitute for purchased fossil fuels. Moreover, state and federal credits may be available from reducing the carbon intensity of transportation fuels can be monetized. In some implementations, the cost of renewable hydrogen production may be significantly lower with significantly lower carbon intensity than either the current practice of using diesel and gasoline fossil fuels or the alternative practice of using landfill gas for vehicle fuel for waste transportation and management.

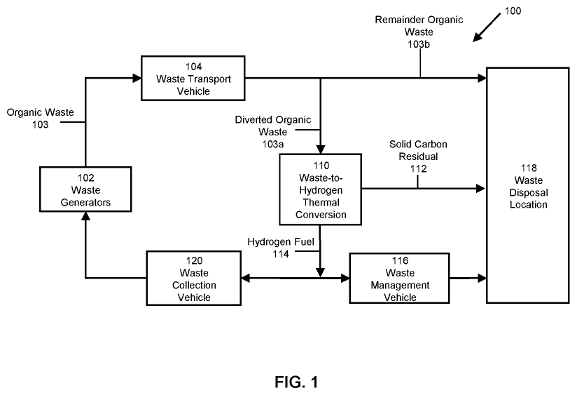

FIG. 1 shows a flow diagram of an example process 100 for generating fuel from organic waste as described in this specification. Normally, organic waste is collected from waste generators and transported via a waste transport vehicle to a centralized waste disposal location, such as a waste disposal location 118, e.g., a landfill. In the technologies described herein, organic waste 103 is collected from one or more waste generators 102 (e.g., a municipal waste collection facility) and transported via a waste transport 104 vehicle. At least a portion of the organic waste 103 is diverted as a diverted organic waste 103a and transferred to a thermal waste-to-hydrogen conversion process 110, e.g., as described in this specification. The remainder of the organic waste 103, if any, e.g., remainder organic waste 103b, can be transported and disposed of at a waste disposal location 118 (e.g., a landfill).

In the waste-to-hydrogen conversion process 110 the organic waste, e.g., diverted organic waste 103a, is heated in the absence of oxygen in a process called pyrolysis as described in the this specification. The organic waste, e.g., diverted organic waste 103a, is heated to temperatures suitable for the release of a mixture of gasses called biogas, which includes, e.g., hydrogen, methane, carbon monoxide, and carbon dioxide (and from which hydrogen fuel 114 can be separated and extracted as output from waste-to-hydrogen conversion process 110). Moreover, non-volatile components, carbon and ash are generated, which are retained in a solid carbon residual 112. Solid carbon residual 112 can be transported and disposed of at a waste disposal location 118. In some implementations, the hydrogen fuel 114 can be used as fuel for a waste collection vehicle 120, e.g., for collection of waste material from residential buildings and transport of waste material to waste generator 102 (e.g., a municipal waste collection or storage facility). In some implementations, the hydrogen fuel 114 can be used as fuel for a waste transport vehicle 104. In some implementations, the hydrogen fuel 114 can be used as fuel for a waste management vehicle 116, e.g., an excavator or truck at waste disposal location 118.

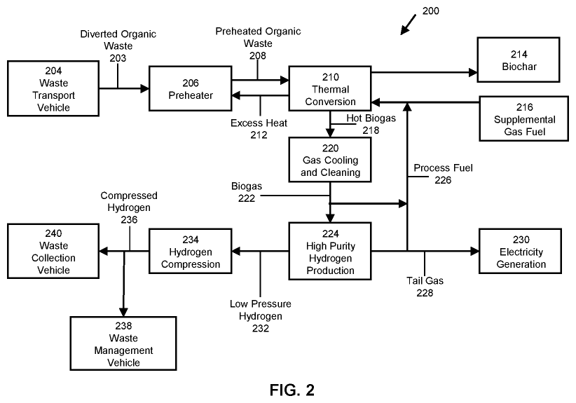

FIG. 2 shows a flow diagram of an example process 200 for generating fuel from organic waste as described in this specification. In the technologies described herein, organic waste is collected from one or more waste generators (e.g., a municipal waste collection facility) and transported via a waste transport vehicle 204. At least a portion of the organic waste is diverted as a diverted organic waste 203 toward a thermal conversion process 210 as described in this specification. Diverted organic waste 203 is or includes solid feed material or carbonaceous “feedstock” for the process described herein. In some implementations, diverted organic waste 203 is delivered to a preheater 206 and preheated. A preheater can use heat (e.g., waste or excess heat 212) from the thermal conversion process 210 to remove moisture or to elevate the waste temperature to reduce the heat energy required in the thermal conversion process 210, or both. In some implementations, waste or excess heat 212 is extracted from exhaust (flue) gas from the thermal conversion process 210, e.g., from a burner used in thermal conversion process 210. In some implementations, waste or excess heat 212 is extracted from biochar 214 (e.g., directly from hot biochar or in a combustion process). Preheated organic waste 208 (feedstock) is fed to the thermal conversion process 210 where the preheated organic waste 208 is heated to a temperature and for a time period necessary to liberate volatile gasses from the feedstock. The non-volatile solids, e.g., char or biochar 214, exit the thermal conversion process 210 separately from the liberated volatile gasses, e.g., hot biogas 218. The liberated volatile gasses are subsequently treated in a gas cooling and cleaning process 220 (e.g., using a gas cooling and/or cleaning system), to remove, e.g., soot particles and gasses that condense into liquids at ambient temperatures.

Biogas can have a certain calorific value that can be sufficient for use of the biogas as fuel in a combustion process. In some implementations, the biogas has a calorific value between 250 and 1100 British Thermal Units per standard cubic foot. A portion of the cleaned volatile gasses (e.g., biogas 222) can be used as an energy or heat source, e.g., via combustion in a burner used in the thermal conversion process 210, e.g., as part of process fuel 226 of thermal conversion process 210. Process fuel 226 can be mixed with a supplemental gas fuel 216, e.g., natural gas. In some implementations, process fuel 226 can be used as fuel for preheater 206. Another portion of biogas 222 can used as a gaseous feedstock to produce and/or separate high purity hydrogen (e.g., low pressure hydrogen 232) from other gasses (e.g., tail gas 228) in a high purity hydrogen production process 224 (e.g., using a high purity hydrogen production system). A portion of the tail gas 228 can be used as an energy or heat source e.g., via combustion in the thermal conversion process 210, e.g., as part of process fuel 226 of thermal conversion process 210. A portion of the tail gas 228 can used as a fuel source for electricity generation process 230, e.g., using a steam turbine and electric generator coupled to the turbine. The generated electricity can be used to meet some or all of the electricity needs of the overall process 200.

Low pressure hydrogen 232 can be compressed, e.g., in a hydrogen compression process 234 (e.g., using a gas compression system). Compressed hydrogen gas 236 can be used as fuel for a waste management vehicle 238, e.g., an excavator or truck at a waste disposal location 118. Compressed hydrogen gas 236 can be used as fuel for a waste collection vehicle 240, e.g., for collection of waste material from residential buildings and transport of waste material to waste generator 102 (e.g., a municipal waste collection facility) or a waste transport vehicle 104.

Organic waste as described herein includes liquid or solid organic material (or a mixture thereof) that can be used as input material (or “feed material” or “feedstock”) in the technologies described in this specification. Organic waste (or feedstock) can be pre-dried, dried and/or preheated prior to use with the technologies described in this specification. Heating of the input or feed material is accomplished by applying an external heat source without oxygen under anaerobic conditions (anoxic) to prevent combustion of the (e.g., solid) input material. At least a portion of the input material can be a biogenic plant material that was produced by converting atmospheric carbon dioxide and water into carbohydrates, lignins, and other plant materials via photosynthesis. An output solid can be a residual carbonaceous solid, and can exit the gas production process described herein separately from output gasses.

A thermal conversion process (or gas production process), e.g., the thermal conversion process 210 or waste-to-hydrogen thermal conversion process 110, is generally anoxic, typically involving an anoxic heating process, e.g., a pyrolysis process. In general, a thermal conversion process is executed at a temperature that liberates combustible gases (e.g., biogas 218) and a residual carbonaceous solid (e.g., biochar 214) from the input feedstock (e.g., diverted organic waste 103a or preheated organic waste 208). In some implementations, combustible, liberated gases (e.g., biogas 218) have sufficient calorific value that can be harvested and used, e.g., as energy source, e.g., to generate heat. The calorific value of the liberated gases also can provide the heat required for heating the input feedstock in the thermal conversion process (or at least a portion thereof). Harvesting and using the liberated gases and extracting the residual carbonaceous solid serves to reduce the carbon footprint of a waste management process. That reduction can be further enhanced by recycling the liberated gases into the one or more stages of process 100 or process 200 that require heat, e.g., preheater 206.

A thermal conversion process (or gas production process), e.g., the thermal conversion process 210 or waste-to-hydrogen thermal conversion process 110, that can be used with the technologies described in this specification can be or can include a pyrolysis process, e.g., using a pyrolyzer. In a pyrolysis process used in the technologies described in this specification, the feedstock is not in direct contact with a flame. In some implementations, hot gas can be produced in an external burner to transfer heat to feedstock through the walls of pipes (retorts) through which the feedstock continuously travels, liberating gasses when the feedstock reaches pyrolysis temperatures. In some implementations, an example burner can use natural gas as a fuel. In some implementations, an example burner can use biogas, e.g., biogas 222, as a fuel. In some implementations, an example burner can use tail gas, e.g., tail gas 228 as a fuel. In some implementations, an example burner can use a combination of natural gas and biogas, or a combination of natural gas and tail gas, or a combination of biogas and tail gas, or a combination of natural gas, biogas and tail gas as fuel.

An example pyrolysis process that can be used with the technologies described in this specification can occur over a range of heating rates. An optimal rate can be selected in conjunction with the desired temperature based on the selected inputs (feedstocks), e.g., organic waste. The pyrolysis heating rate can be between about 1° C./min and about 15° C./min. In some implementations, the heating rate can be between about 4° C./min and about 12° C./min. In some implementations, the heating rate is between about 7° C./min and about 9° C./min. In some implementations, the heating rate of the pyrolysis is about 8° C./min. In some implementations, other methods of gas production can be used in combinations with the anoxic heating process described in this specification. For example, combustion, carbonization, charring, and/or devolatilization technologies can be used, for example, combustion, carbonization, charring, and/or devolatilization technologies with similar or identical temperatures and heating rates to the pyrolysis conditions discussed above.

An example pyrolysis process as described in this specification can occur over a range of temperatures, the optimal temperature being selected as needed to liberate sufficient combustible gas from the specific feedstock. In some implementations, the temperature can be up to about 800° C. In some implementations, the temperature can be between about 400° C. and about 800° C., or between about 450° C. and about 750° C. In some implementations, the temperature may be between about 500° C. and about 700° C. In some implementations, the temperature can be between about 500° C. and about 700° C. In some implementations, the temperature can be about 600° C.

Liberated gases (the volatile gases liberated by the gas production process, e.g., biogas 218) can subsequently treated in gas cleaning step, e.g., gas cooling and cleaning process 220. A gas cleaning step can be implemented to remove soot particles and/or non-desirable gases, such as acidic gases like hydrogen sulfide, hydrogen chloride, hydrogen fluoride, ammonia, volatilized metals, carbon dioxide or other undesirable gases, e.g., gases that condense into liquids or reduce the heat value of the gas.

A thermal conversion process, e.g., the thermal conversion process 210 or waste-to-hydrogen thermal conversion process 110 can utilize a fuel gas, e.g., supplemental fuel gas 216. Fuel gas (or heating gas) can include natural gas from a natural gas source, although other carbon-based fuels can also be used additionally or alternatively. A stream of combustible output gasses, e.g., biogas, e.g., biogas 222, can be recycled and included as an input into a gas production process and/or thermal conversion process. The stream of recycled gas can include methane and other gasses that produce heat when combusted. In some implementations, a first portion of the output gas, e.g., biogas, e.g., biogas 222, has a first calorific value of about 600 British Thermal Units per standard cubic foot (BTU/cf), or between about 250 BTU/cf and about 1100 BTU/cf, or between about 400 Btu/cf and about 850 BTU/cf, or between about 550 BTU/cf and about 700 BTU/cf. In some implementations, the output gas includes one or more of hydrogen, carbon monoxide, carbon dioxide, methane, and other hydrocarbons.

In some implementations, a thermal conversion process, e.g., the thermal conversion process 210 or waste-to-hydrogen thermal conversion process 110, can include a hydrogen separation system and/or separation process as described in this specification to create hydrogen gas and a tail gas, e.g., tail gas 228. Tail gas can include one or more of methane, ethane, ethylene, propylene, C6+ hydrocarbons, carbon monoxide, carbon dioxide, or hydrogen. In some implementations, at least a portion of the tail gas can be recycled and used as an input to the thermal conversion/gas production process, e.g., as part of process fuel 226. The tail gas can have a calorific value above 600 BTU/cf, or between about 250 BTU/cf and about 1100 BTU/cf, or between about 400 Btu/cf and about 850 BTU/cf, or between about 550 BTU/cf and about 700 BTU/cf.

The technologies described in this specification can include a hydrogen separation system and/or process, e.g., a high purity hydrogen production system and/or method 224. In some example implementations, gas mixtures, e.g., biogas, can be separated using synthetic membranes made from polymers such as polyamide or cellulose acetate, or from ceramic materials. In some implementations, hydrogen can be selectively removed from the volatile gasses by pressure swing adsorption (PSA) and/or other processes. Suitable adsorbents include, but are not limited to, activated carbon, silica, zeolite, and resin. In some implementations, hydrogen gas produced using the technologies described herein can produce a hydrogen gas that is over 80% or over 90% pure hydrogen, e.g., 99% pure hydrogen. In some implementations, biogas or hydrogen generated using the methods described in this specification can be used as an energy source or energy carrier, for example, as a fuel, for example, in a vehicle or in a building. In some specific implementations, hydrogen generated using the technologies described in this specification can be used to power a truck, for example a waste transport vehicle that is used to collect, e.g., household waste and transports the waste to, e.g., a municipal waste processing facility. In some implementations, hydrogen generated using the technologies described in this specification can be used to power a waste management vehicle, e.g., an excavator used at a waste management facility. Hydrogen generated using the technologies described in this specification can be used as fuel in a fuel cell or other electrochemical device, or can be used as fuel in an internal combustion engine, e.g., in a fuel cell or internal combustion engine powering a truck as described herein. The technologies described in this specification utilize energy extracted from waste products and can thereby reduce the carbon footprint of waste removal or waste handling processes, e.g., by reducing the reliance of external fuel or other energy sources, e.g., natural gas.

### Example Implementations

Item 1. A method for producing transportation fuel, the method including:
   heating, in a thermal conversion process, a solid feed material in the absence of oxygen to liberate gas and residual carbonaceous solid, the gas having a calorific value;
   utilizing a portion of the liberated gas to produce hydrogen for use as a transportation fuel;
   utilizing the remaining portion of the liberated gas to produce renewable heat and electricity to reduce an overall carbon intensity of the transportation fuel production process; and
   capturing the residual carbonaceous solid as a waste product for landfill disposal or use as a fuel, soil amendment, concrete additive, or various carbon applications.
Item 2. The method of item 1, wherein the solid feed material is carbonaceous waste material that is transported to a landfill and/or other centralized waste disposal location using a vehicle for waste transport and/or management.
Item 3. The method of item 1 or item 2, wherein the solid feed material originates as a biogenic plant material produced via photosynthesis that converts atmospheric carbon dioxide and water into carbohydrates.
Item 4. The method of any of items 1-3, wherein the solid feed material is preheated, e.g., in a preheater configured to reduce a moisture content and/or elevate a temperature of the solid feed material to reduce the heat energy required to heat the solid feed material to a temperature sufficient to liberate gasses.
Item 5. The method of item 4, wherein the solid feed material is preheated using heat extracted from flue gas generated in the thermal conversion process.
Item 6. The method of item 4 or item 5, wherein the solid feed material is preheated using heat extracted from the liberated gas.
Item 7. The method of any of items 4-6, wherein the solid feed material is preheated using heat extracted from the residual carbonaceous solid.
Item 8. The method of any of items 1-7, wherein the liberated gasses include one or more of hydrogen, methane, carbon monoxide, carbon dioxide, and/or a mixture of various hydrocarbons.
Item 9. The method of items 1-8, wherein the liberated gas has a calorific value between 250 and 1100 British Thermal Units per standard cubic foot.
Item 10. The method of items 1-9, wherein a portion of the liberated gas is used to produce hydrogen for use as a vehicle fuel.
Item 11. The method of item 10, wherein the hydrogen is used as fuel for a waste transportation or a waste management vehicle.
Item 12. The method of items 1-11, wherein a portion of the liberated gas is used as a fuel in a process to produce renewable heat and/or renewable electricity such that the carbon intensity of the produced transportation fuel is reduced.
Item 13. The method of items 1-12, wherein the residual carbonaceous solid is suitable for disposal in a landfill.
Item 14. The method of items 1-13, wherein the residual carbonaceous solid is used as a replacement fuel, e.g., for coal.
Item 15. The method of items 1-14, wherein the residual carbonaceous solid is used as a soil amendment to improve water retention and plant yield characteristics for soils.
Item 16. The method of items 1-15, wherein the residual carbonaceous solid is used as an additive to increase the strength of concrete.
Item 17. The method of items 1-16, wherein the residual carbonaceous solid is used as a source of carbon.
Item 18. A system for producing transportation fuel from carbonaceous waste for vehicles that transport the waste to and manage the wastes in landfills and other centralized waste management locations, the system including:
   a thermal conversion system configured to heat a solid waste feed material in the absence of oxygen to (a) liberate gas that comprises hydrogen and other constituents having a calorific value from the solid and (b) produce a residual carbonaceous solid;
   a preheating system that uses excess heat from the thermal conversion system configured to remove moisture, increase waste temperature, and/or reduce the heat required in the thermal conversion process;
   a gas cooling and/or cleaning system configured to treat liberated volatile gasses from the gas production unit to remove soot particles and/or gasses that condense into liquids at ambient temperatures to produce a biogas; and
   a high purity hydrogen production system configured to produce, from the biogas, a gas product including hydrogen and a residual tail gas comprising removed non-hydrogen gasses in the biogas.
Item 19. The system of item 18, wherein the gas product is greater than 99% hydrogen.
Item 20. The system of item 18 or item 19, including an electricity generator capable of utilizing biogas or tail gas for production of electricity for use in the transportation fuel production process.
Item 21. The system of items 18-20, including a waste transportation and/or waste management vehicle that uses the gas product as an energy source either in an internal combustion engine or an electrical motor powered by a fuel cell.

What is claimed is:

1. A method for producing transportation fuel, the method comprising:
heating, in a thermal conversion process, a solid feed material in the absence of oxygen to liberate gas and residual carbonaceous solid, the gas having a calorific value;
utilizing a portion of the liberated gas to produce hydrogen for use as a transportation fuel;
utilizing the remaining portion of the liberated gas to produce renewable heat and electricity to reduce an overall carbon intensity of the transportation fuel production process; and
capturing the residual carbonaceous solid as a waste product for landfill disposal or use as a fuel, soil amendment, concrete additive, or various carbon applications.

2. The method of claim 1, wherein the solid feed material is carbonaceous waste material that is transported to a landfill or other centralized waste disposal location using a vehicle for waste transport and/or management.

3. The method of claim 1, wherein the solid feed material originates as a biogenic plant material produced via photosynthesis that converts atmospheric carbon dioxide and water into carbohydrates.

4. The method of claim 1, wherein the solid feed material is preheated in a preheater configured to reduce a moisture content and elevate a temperature of the solid feed material to reduce the heat energy required to heat the solid feed material to a temperature sufficient to liberate gasses.

5. The method of claim 4, wherein the solid feed material is preheated using heat extracted from flue gas generated in the thermal conversion process.

6. The method of claim 4, wherein the solid feed material is preheated using heat extracted from the liberated gas.

7. The method of claim 4, wherein the solid feed material is preheated using heat extracted from the residual carbonaceous solid.

8. The method of claim 1, wherein the liberated gasses comprise hydrogen, methane, carbon monoxide, carbon dioxide, and a mixture of various hydrocarbons.

9. The method of claim 1, wherein the liberated gas has a calorific value between 250 and 1100 British Thermal Units per standard cubic foot.

10. The method of claim 1, wherein a portion of the liberated gas is used to produce hydrogen for use as a vehicle fuel.

11. The method of claim 10, wherein the hydrogen is used as fuel for a waste transportation or a waste management vehicle.

12. The method of claim 1, wherein a portion of the liberated gas is used as a fuel in a process to produce renewable heat and/or renewable electricity such that the carbon intensity of the produced transportation fuel is reduced.

13. The method of claim 1, wherein the residual carbonaceous solid is suitable for disposal in a landfill.

14. The method of claim 1, wherein the residual carbonaceous solid is used as a replacement fuel for coal.

15. The method of claim 1, wherein the residual carbonaceous solid is used as a soil amendment to improve water retention and plant yield characteristics for soils.

16. The method of claim 1, wherein the residual carbonaceous solid is used as an additive to increase the strength of concrete.

17. The method of claim 1, wherein the residual carbonaceous solid is used as a source of carbon.

18. A system for producing transportation fuel from carbonaceous waste for vehicles that transport the waste to and manage the wastes in landfills and other centralized waste management locations, the system comprising:
a thermal conversion system configured to heat a solid waste feed material in the absence of oxygen to (a) liberate gas that comprises hydrogen and other constituents having a calorific value from the solid and (b) produce a residual carbonaceous solid;
a preheating system that uses excess heat from the thermal conversion system configured to remove moisture, increase waste temperature, and/or reduce the heat required in the thermal conversion process;
a gas cooling and/or cleaning system configured to treat liberated volatile gasses from the gas production unit to remove soot particles and/or gasses that condense into liquids at ambient temperatures to produce a biogas; and
a high purity hydrogen production system configured to produce, from the biogas, a gas product comprising greater than 99% hydrogen and a residual tail gas comprising removed non-hydrogen gasses in the biogas.

19. The system of claim 18, comprising an electricity generator capable of utilizing biogas or tail gas for production of electricity for use in the transportation fuel production process.

20. The system of claim 18, comprising a waste transportation and/or waste management vehicle that uses the gas product as an energy source either in an internal combustion engine or an electrical motor powered by a fuel cell.
